(19) United States
(12) Patent Application Publication
(10) Pub. No.: US 2008/0092244 A1
(43) Pub. Date: Apr. 17, 2008

(54) Method For Restricting Content Usage In Digital Rights Management

(76) Inventor: Seung-Jae Lee, Gyeonggi-Do (KR)

Correspondence Address: BIRCH STEWART KOLASCH & BIRCH, PO BOX 747, FALLS CHURCH, VA, 22040-0747, US

(21) Appl. No.: 11/814,776

(22) PCT Filed: Apr. 6, 2006
(86) PCT No.: PCT/KR06/01264

§ 371 Date: Jul. 25, 2007

(30) Foreign Application Priority Data
Apr. 15, 2005 (KR) 10-2005-0031657

(51) Int. Cl. H04L 9/32

(52) U.S. Cl. 726/28

(57) ABSTRACT

A method for restricting content usage in a digital rights management, in which in order to restrict or grant content usage in a certain geographic location, a geographic usage condition is additionally included in an RO of the content, and a terminal which downloads the RO checks the geographic usage condition to thus restrict or grant the using of the content in the corresponding location or area, wherein the geographic usage condition includes an item for restricting the protected using of the content and/or an item for granting the same, each item including information related to a location or area.

### TECHNICAL FIELD

The present invention relates to a Digital Rights Management (DRM), and more particularly, a method for restricting content usage in a digital rights management which is capable of limiting content usage in a certain geographic location.

### BACKGROUND ART

A Digital Rights Management (DRM) refers to a system technology for safely protecting and systematically managing rights in digital contents. The DRM provides a prevention of illicit content copy and a grant of content usage rights, generation and distribution of contents, and a system for protecting and managing usage processes.

FIG. 1 illustrates a construction of a DRM system in which a content provider regulates such that a user who receives contents sent from the provider can use the contents by a rights object (RO) grated to him. Here, the content provider may be an entity corresponding to a Content Issuer (CI) and/or a Rights Issuer (RI).

The CI issues a content which is protected using a particular cryptographic key to thus protect the content from users who are not grated to view/read the content, while the RI issues an RO required to use the protected content.

A DRM agent is mounted in a terminal to receive the protected content and the RO. The DRM agent then analyzes a license included in the RO and thus changes the protected content into a format which is usable in the corresponding terminal, thereby regulating the usage of the content.

In the related art DRM, the RO for a certain content may include various types of usage conditions in which the corresponding content can be used. For example, the usage conditions may include the number of times, datetime, period (or interval) or system for using the corresponding content.

### DISCLOSURE OF INVENTION

### Technical Problem

However, in the related art DRM, the RO may not include a condition for restricting or granting the content usage in a certain geographic location. That is, the related art DRM does not provide a method for restricting or granting the content usage based upon a geographic location.

### Technical Solution

Therefore, it is an object of the present invention to provide a method for restricting content usage in a Digital Rights Management (DRM) which is capable of allowing a content to be used in a certain geographic location by adding an item with respect to location information (i.e., geo-location, positioning, etc.) corresponding to a geographic usage condition within a content Rights Object (RO).

To achieve these objects, there is provided a method for restricting content usage in a digital rights management, the method comprising: providing a rights object (RO) including a usage condition for allowing the content to be used in a particular location.

To achieve these objects, there is provided a method for restricting content usage in a DRM comprising checking, by a terminal having received a certain content and a rights object for the corresponding content, whether the usage conditions of the corresponding rights object contains a geographic usage condition for granting or denying the using of the content in a certain location, comparing positioning (i.e., geo-location) contained in the corresponding geographic usage condition with a current location value of the terminal when the geographic usage condition is contained in the usage conditions of the rights object, and executing the content or restricting the using of the content according to the usage condition when the location value of the terminal is included in the positioning.

### BRIEF DESCRIPTION OF THE DRAWINGS

FIG. 1 is a diagram illustrating an exemplary construction of a typical DRM system;

FIG. 2 is a diagram illustrating a DRM system in accordance with an embodiment of the present invention;

FIG. 3 is an exemplary view displaying a rights object of a content according to the present invention;

FIG. 4 is an exemplary view showing a format for a location information (i.e., geo-location) item corresponding to a geographic usage condition according to the present invention;

FIG. 5 is an exemplary view showing a format for a grant item (granted) within the geo-location item;

FIG. 6 is an exemplary view showing a format for a denial item (denied) within the geo-location item;

FIG. 7 is an exemplary view showing a format for location information in the grant item (granted) and/or the denial item (denied);

FIG. 8 is an exemplary view showing a format for area information in the grant item (granted) and/or the denial item (denied); and

FIG. 9 is an exemplary view illustrating an embodiment of a right object using the geo-location corresponding to a geographic usage condition in accordance with the present invention.

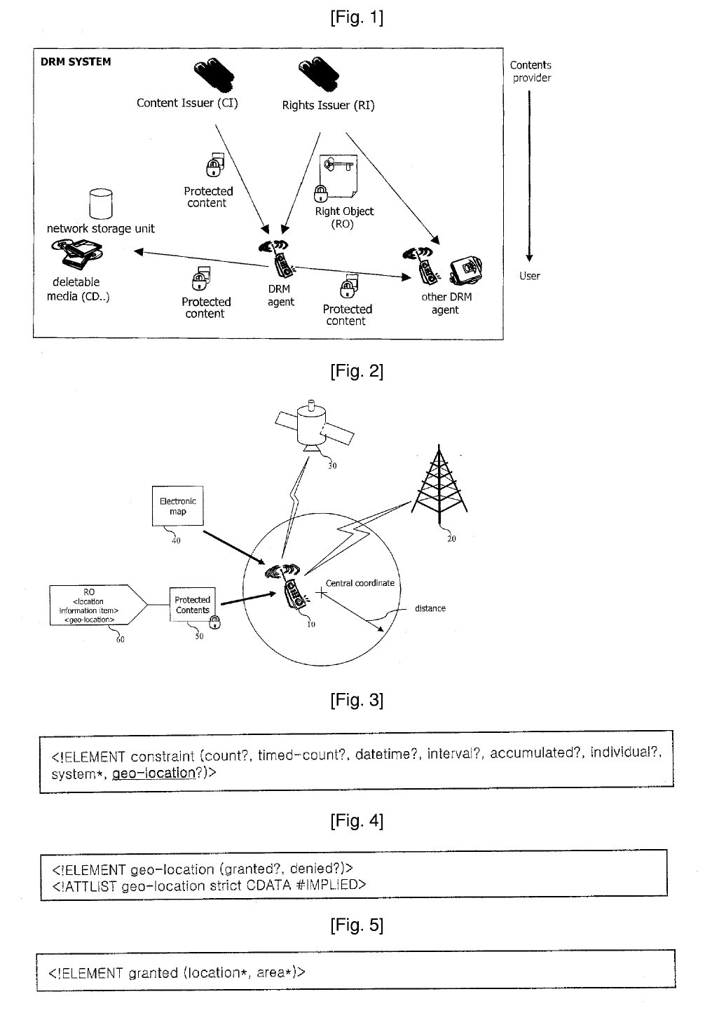

### MODE FOR THE INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Hereinafter, embodiments of a method for restricting content usage in a Digital Rights Management (DRM) according to the present invention will now be explained with reference to the attached drawings.

The present invention can include a usage condition related to a geographic location with respect to a content within a content rights object for restricting or granting content usage in a certain geographic location.

The usage condition related to the geographic location (hereafter, referred to as a geographic usage condition) includes an item for restricting the using of a content or an item for granting the using of the content. The items may include, as their subordinate item, information related to a location based upon a particular place or to an area based upon division according to a certain reference.

According to the present invention, a terminal which receives a certain content and a Rights Object (RO) related to the content compares its location value with a geographic usage condition within the received RO and determines whether to use the content according to the comparison. Here, the terminal can receive its location value from a base station or control station through a location detecting module such as a Global Positioning System (GPS) module mounted therein or the like, or can directly calculate its location value. In addition, the terminal can receive its location value from a separate entity such as a state information server or a location information server to thus compare it with the geographic usage condition within the RO.

FIG. 2 illustrates a construction of a DRM system in accordance with an embodiment of the present invention. the DRM system may comprise, for example, a terminal 10 having a location detecting module for recognizing and/or calculating a location such as a GPS module, a base station 20, and a satellite 30 for checking the location of the terminal 20 having the location detecting module.

The terminal 10 downloads an electronic map 40, a content 50 protected using a certain cryptographic key, and a Rights Object (RO) 60 with respect to the content 50. Here, the RO 60 may include usage conditions of the corresponding content.

In general, the usage conditions may include items such as the number of times for counting (i.e., count), the number of times for counting by a time unit (i.e., timed-count), a datetime, an interval (or period), an accumulation, an individual, and a system. Also, the present invention may further include an item related to location information (i.e., geo-location, positioning, and the like).

The number of times for counting (Count) denotes an item for restricting how many times the content can be used. The number of times for counting according to time (Timed-count) denotes an item for restricting the number of times for using the content by considering a constant time elapse as an one-time use, and the datetime denotes an item for restricting the using of the content by setting a starting time and a terminating (stopping) time. The interval (or period) denotes an item for allowing (granting) the using of the corresponding content for a certain period after starting using the content. The accumulation denotes an item for granting the using of the content until a certain limited time by accumulating a total time taken by using the content. In addition, the individual denotes an item for granting the using of the content for only a certain user, and the system denotes an item for restricting a system in which the content can be used.

The geo-location additionally included in the present invention corresponds to the geographic usage condition, which denotes an item for indicating locations in which the using of the content is granted or denied.

FIG. 3 is an exemplary view displaying an RO of a content according to the present invention, wherein the RO which is extended by adding the geo-location item corresponding to the geographic usage condition is represented using an eXtensible Markup Language (XML) format.

The geo-location item includes as its subordinate items, a grant item (granted) for granting the using of the content and a denial item (denied) for denying the using of the content. Here, the grant item (granted) and the denial item (denied) can not be simultaneously included in the geo-location item. FIG. 4 is an exemplary view showing a format for the geo-location item.

If the geo-location item exists (or is contained) in a condition (constraint) item of the XML instance, the geographic usage condition with respect to the geo-location may generally be applied to a case of the corresponding terminal s having a location detecting module by which a current location of the terminal using the contents can be detected and/or a location of the terminal can be calculated.

If the location detecting module is not mounted in the corresponding terminal, the terminal may separately have an application method (strict) which is an attribute for construing the geo-location item or for defining a scheme for applying the geo-location item.

For example, if a value of the attribute is set to YES, true or 1, there is no way to construe the RO, thereby restricting the using of the content. If the value of the attribute is set to NO, false or other values except for 1, it may be considered as the geographic usage condition corresponding to the geo-location item has not been set to thus skip the checking of the location. In addition, if any value for the attribute is not set, the value of the application method can basically be regarded as being set to false.

FIG. 5 is an exemplary view showing a format for the grant item (granted) which denotes a place in which it is granted to use the content, wherein the grant item (granted) may include no subordinate item or one or more location information related items and one or more area information related items.

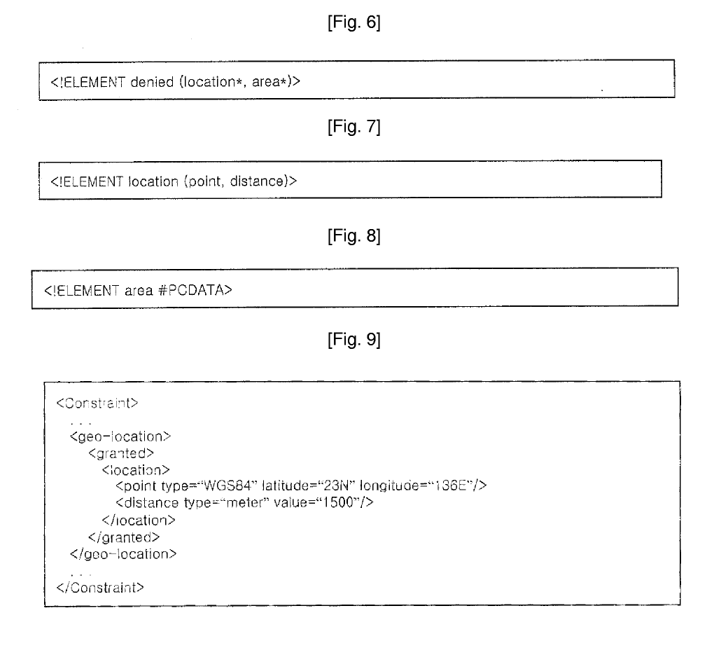

FIG. 6 is an exemplary view showing a format for the denial item (denied) which denotes a place in which it is denied to use the content, wherein the denial item (denied) may include no subordinate item or one or more location information items and one or more area information items.

The location information related item corresponds to location information based upon a particular point and thus can be a geo-location (positioning) which can be represented with point and distance (or semi-diameter). Here, the point item includes a coordinate value indicating a certain point and a type of a coordinate system for expressing the coordinate value of the certain point, and the distance item includes a distance value from the certain point and a type of unit expressing the distance value. FIG. 7 is an exemplary view showing a format with respect to the location information related item.

FIG. 8 is an exemplary view showing a format with respect to the area information related item. The area information related item corresponds to area information based upon a division according to a certain reference and may thus be a geo-location (positioning) which is divided by nations, districts, cities, an the like, on an electronic map, for example. Here, detail of the area item depends on data of the electronic map. The geo-location indicated with Seoul, Korea corresponds to a location within a boundary of Seoul city on the electronic map.

FIG. 9 illustrates an embodiment of an RO using a geo-location (positioning) corresponding to a geographic usage condition according to the present invention, wherein the RO can be used only within a semi-diameter (distance) of 1500 m based upon 23° (degrees) of north latitude and 136° (degrees) of east longitude using WGS84 coordinate system.

The RO condition (constraint) of the content includes the geo-location item. The geo-location item includes the grant item (granted). The grant item (grant) includes the location information related item. The location information related item includes the point item indicating 23° (degrees) of north latitude and 136° (degrees) of east longitude using WGS84 coordinate system and a semi-diameter (distance) item indicating the distance of 1500 m from the point.

According to the present invention, the terminal which has received a certain content and an RO therefor checks whether a geo-location (positioning) corresponding to a geographic usage condition is contained (exists) in usage conditions within the RO. If the geo-location (positioning) is contained in the RO, the terminal compares its location value with the positioning to determine whether to use the corresponding content. Here, the terminal may receive its location value from a base station or a control station through a location detecting module mounted therein or directly calculate its location value from certain information. In addition, the terminal may receive its location value from a separate entity such as a state information server or a location information server to thus compare its current location value with the geographic usage condition within the RO, thereby determining whether to use the content.

As aforementioned, regarding the method for restricting the content usage in the DRM according to the present invention, by additionally including a geo-location (positioning) corresponding to the geographic usage condition in the RO of the content, the content can effectively be restricted or granted to be used in a particular location.

In addition, regarding the method for restricting the content usage in the DRM according to the present invention, since the right issuer can restrict or grant the content usage based upon the geo-location (positioning), the content usage can effectively be controlled more flexibly than using a method for restricting/granting the content usage only by using conditions related to the number of times or time period (interval).

1. A method for restricting content usage in a digital rights management, the method comprising:
providing a rights object including a usage condition for allowing the content to be used in a particular location.

2. The method of claim 1, wherein the usage condition includes, as a sub-items thereof, one of a grant item indicating a location in which the content is able to be used and a denial item indicating a location in which the content is disable to be used.

3. The method of claim 2, wherein the grant item and the denial item are not simultaneously included in the usage condition.

4. The method of claim 3, wherein the grant item and the denial item include one or more location information related items based upon a certain point, as sub-items thereof.

5. The method of claim 3, wherein the grant item and the denial item include one or more area information related items based upon a territory according to a certain reference, as sub-items thereof.

6. The method of claim 4, wherein the location information related item denotes positioning which is represented using at least one or more of point information and distance information.

7. The method of claim 6, wherein the point information is indicated using a type of geographic coordinate and a coordinate value.

8. The method of claim 6, wherein the distance information is indicated using a distance value from the point and a unit type of the distance value.

9. The method of claim 5, wherein the area information related item denotes a positioning information which is represented based upon administrative districts on electronic map data.

10. A method for restricting content usage in a digital rights management comprising:
checking, by a terminal which receives a certain content and a rights object for the corresponding content, whether usage conditions of the corresponding rights object include a geographic usage condition for granting or denying the using of the content;
comparing a current location value of the terminal itself with positioning within the corresponding geographic usage condition when the geographic usage condition is contained in the rights object; and
executing the content or restricting the using of the content according to the usage conditions when the location value of the terminal is contained in the positioning.

11. The method of claim 10, further comprising obtaining, by the terminal, the location information of the terminal.

12. The method of claim 11, wherein the location value is calculated by the terminal itself or received from an external entity.

13. The method of claim 10, wherein the executing the content or restricting the using of the content includes:
checking whether the terminal is currently positioned in a location where the using of the content is granted or in a location where the using of the content is restricted;
executing the content when the terminal is currently positioned in the location where the using of the content is granted; and
restricting the using of the content when the terminal is currently positioned in the location where the using of the content is restricted.
